(19) United States
(12) Patent Application Publication
(10) Pub. No.: US 2024/0188609 A1
(43) Pub. Date: Jun. 13, 2024

(54) HIGH-DIETARY-FIBER BERRY-POMACE-POWDER AND USE THEREOF IN FOOD PRODUCTS

(71) Applicant: Kaunas University of Technology, Kaunas (LT)

(72) Inventors: Daiva Leskauskaite, Kaunas (LT); Petras Rimantas Venskutonis, Kaunas (LT); Milda Kersiene, Kaunas (LT); Ina Jasutiene, Kaunas (LT); Ieva Jureviciute, Kaunas (LT); Laurita Varnaite-Kapoce, Kaunas (LT); Loreta Basinskiene, Kaunas (LT); Jolita Jagelaviciute, Kaunas (LT)

(21) Appl. No.: 18/064,301

(22) Filed: Dec. 12, 2022

(51) Int. Cl. A23L 19/00; A23C 9/13; A23L 13/60; A23L 33/22

(52) U.S. Cl. CPC A23L 19/01; A23C 9/13; A23L 13/65; A23L 33/22

(57) ABSTRACT

The invention discloses berry-pomace-powders composition comprising soluble and insoluble dietary fibers which is effective in glucose adsorption, cholesterol and bile acids binding, good antioxidant activity, having excellent technological properties and adapted to be used in food products and provide to consumers dietary fibers without negative effect on the digestibility and bio-accessibility of other nutrients. Also, a method for producing the disclosed berry-pomace-powders compositions comprising high amounts of soluble and insoluble dietary fibers is described. Furthermore, use of the berry-pomace-powder and use examples thereof is provided, for preparation and enrichment of food products. The use examples are enrichment of yogurt, and as food additive into a composition of meat sausages.

### FIELD OF INVENTION

The invention relates to the field of food technology, specifically to a berry-pomace-powder composition and use of it in food products.

### BACKGROUND ART

Rational recycling of food waste into high-value components is an important challenge of this century. Increased demand for plant-based foods has also increased the amount of waste. The processing of berry juice, wine, or other beverages results in a considerable amount of pomace, including skins, seeds, and occasionally stalks. Pomace has been estimated at 30% of the total grape use in winemaking or 60% of the total cranberry use in juice production.

Although berry pomace contains a significant amount of valuable dietary fiber, colorants, antioxidant compounds, and other substances with appreciable health benefits, the majority of them is used as animal feed or composted to organic matter. There are attempts to utilize differently processed berry pomace, using as functional ingredients in feed, food products or food supplements. However berry pomace used in foodstuff production as a source of dietary fiber do not maintain functional properties after adding into food products and throughout gastrointestinal tract or they negatively affect the bioavailability of other nutrients such as proteins, fats, minerals and vitamins during digestion.

The functionality of berry pomace depends primarily on their chemical composition, which is dominated by dietary fiber. American Association of Cereal Chemists (AACC) states that ‘dietary fiber is the remnants of the edible part of a plant or analogous carbohydrates that are resistant to digestion and absorption in the human small intestine with complete or partial fermentation in the large intestine. Dietary fibers may be the pure components like pectin, gum, glucomannan, carrageenan, alginate, inulin, resistant starch, fructo-oligosaccharides, polydextrose, carboxymethyl cellulose, hemicellulose, and lignin or in composite forms like bran, pomace, peel. It is very important that dietary fiber in berry pomace contain a significant number of colorants, antioxidant compounds, and other substances with appreciable health benefits.

Dietary fiber is considered to play an important role in the human diet and health by reducing pre-prandial cholesterol and postprandial blood glucose levels, enhancing gastrointestinal immunity, and increasing the satiety of consumers. In the small intestine dietary fiber act in three physical forms: soluble polymer chains in solution, an insoluble macromolecular assembly, and as swollen, hydrated, sponge-like networks. However, the physiological effect of dietary fiber in the small intestine is to reduce the rate of release of nutrients or antioxidants. For example, dietary fibers added into meat products can bind minerals thus reducing the activity of heme in the colon. Therefore, when adding dietary fiber to various foods, it is important to know whether they will slow down the uptake of other nutrients in the food product.

Also, the incorporation of dietary fiber in food products results in a change of texture which may be desirable or undesirable. Undesirable texture of foods is usually obtained by the addition of dietary fiber content that can be declared in the nutritional fact declaration of the food in accordance with European Union and U.S. legislation. In the U.S. products that contain at least 10% of the daily value or 2.5 grams of fiber per serving can claim they are a “good source of fiber” and those containing at least 20% of the daily value of fiber or 5 grams or more of fiber per serving can label the product with a high fiber claim. In Europe, the product must contain at least 3 g of fiber per 100 g of a product or at least 1.5 g of fiber per 100 calories to qualify for a “source of fiber” claim. To be a “high-fiber” food, the product must contain at least 6 g of fiber per 100 g of a product or at least 3 g of fiber per 100 calories. Therefore, by adding berry pomace as dietary fiber source into food products, their effect on the stability of the product should be tested.

The present invention is dedicated to overcoming of the above shortcomings and for producing further advantages over prior art.

### SUMMARY OF INVENTION

Dietary fibers rich berry pomace powders can be used as functional ingredient in food products due to good hypoglycemic and hypolipidemic effect and high antioxidant activity. Food products produced with added berry pomace powder comprising at least 3 g/100 g product of fiber can be claimed as a “good source of fiber”.

Following these results, it can be assumed that incorporation of dietary fiber rich berry PP in food products can solve the following technological problems:
· ensuring food product stability due to enhanced textural properties;
· ensuring higher nutritional value of food products comprising at least 3 g of dietary fiber in 100 g of product;
· ensuring antioxidant activity and no negative effect on the digestibility of proteins and fats and release of minerals and vitamins throughout gastrointestinal tract.

### DESCRIPTION OF DRAWINGS

The invention is explained in the drawings and graphs. The drawings are provided as a reference to possible embodiments and experimental results, and not intended to limit the scope of the invention. Details that are irrelevant and not necessary to explain the invention, are not provided in the drawings.

FIG. 1 Particles size distribution of berry pomace powder.

FIG. 2 Influence of cranberry pomace on emulsion stability: at room temperature:
(a) after heat treatment at 80° C.;
(b) at different pH. •-pH8, ♦-pH6, ▪-pH4.

FIG. 3 Influence of lingonberry pomace on emulsion stability: at room temperature:
(a) after heat treatment at 80° C.;
(b) at different pH. •-pH8, ♦-pH6, ▪-pH4.

FIG. 4 Influence of sea-buckthorn pomace on emulsion stability: at room temperature:
(a) after heat treatment at 80° ° C.;
(b) at different pH. •-pH8, ♦-pH6, ▪-pH4.

FIG. 5 Glucose adsorption capacity at different concentrations of glucose (5, 10, 50, and 100 mmol/L) of berry PP. Values expressed as average±st.dev. Different letters among columns indicate significant (p<0.05) differences (lower case—among concentrations; capital letters—among berry PP with the same glucose concentration).

FIG. 6 Free α-amino group binding capacity of berry pomace. Values are expressed as average±SD. Different letters among columns indicate significant (p<0.05) differences.

FIG. 7 Vitamin C and B9 binding capacity of berry pomace powders. Columns with different letters indicate significant differences (p<0.05), lower case—among vitamin B9, upper case—among vitamin C.

FIG. 8 Minerals binding capacity of berry pomace powders, where (a) Zn binding; (b) Se binding.

FIG. 9 FTIR spectra of berry pomace powders mixture with Se, compared to FTIR of berry pomace powders at pH 3 and pH 7: (a) cranberry PP, (b) lingonberry PP, (c) sea buckthorn PP.

FIG. 10 Particles size distribution of yogurt made by adding different amount of CPP: (a) after fermentation, and (b) before fermentation.

FIG. 11 SEM micrographs of yogurt: (a) without CPP, and (b) with 4.5% of CPP added after, and (c) with 4.5% of CPP added before fermentation.

FIG. 12 Viability of LAB of yogurt made by adding different amount of CPP after (I method) and before fermentation (II method). Values are reported as means±standard deviation; lower case letters indicate significant (p<0.05) differences between different CPP content in yogurt; upper case letters indicate significant (p<0.05) differences between different CPP addition method.

FIG. 13 Changes of pH of yogurt with different amount of CPP during storage (28 days). (a)—yogurt made by adding CPP after fermentation (I method); (b)—yogurt produced by adding CPP before fermentation (II method).

FIG. 14 Viability of LAB of yogurt made by adding different amount of CP during storage (28 days). (a)—yogurt made by adding CPP after fermentation (I method); (b)—yogurt produced by adding CPP before fermentation (II method). Different letters indicate significant (p<0.05) differences between values at different storage period.

FIG. 15 Syneresis of yogurt made by adding different amount of CPP during storage (28 days). (a)—yogurt made by adding CPP after fermentation (I method): (b)
yogurt produced by adding CPP before fermentation (II method). Different letters indicate significant (p<0.05) differences between values at different storage period.

FIG. 16 Total phenolic compounds content in yogurt made by adding different amount of CP during storage (28 days). (a)—yogurt made by adding CPP after fermentation (I method); (b)—yogurt produced by adding CPP before fermentation (II method). Different letters indicate significant (p<0.05) differences between values at different storage period.

FIG. 17 Changes in antioxidant activity of yogurt made by adding different amounts of CC after fermentation during static in vitro digestion. Values are reported as means±standard deviation; lower case letters indicate significant (p<0.05) differences between different CP content in yogurt; upper case letters indicate significant (p<0.05) differences between different CP addition method. Where a—DPPH; b—ABTS; c—ORAC.

### DETAILED DESCRIPTION OF INVENTION

The present invention discloses a dietary fiber rich berry pomace powder (PP) composition. The composition comprises berry PP comprising dietary fiber (DF) with soluble DF/insoluble DF ratio in the range of 0.11-0.22. The composition comprises total insoluble dietary fiber in the range 63.56±1.11 g/100 g to 71.61±0.35 g/100 g; total soluble dietary fiber in the range 6.72±0.44 g/100 g to 13.98±0.18. The cholesterol binding capacity of the composition is in the range of 14.16^{c} ±0.01 23.13^{b}±0.47 mg/g. The sodium cholate binding capacity, at pH7, of the composition is in the range of 24.66^{d}±5.80 mg/g to 52.68_{b}±2.07 mg/g. Total phenolic content from 5,65±0.01 mg GA/g sample to 13,54±0,37 GA/g.

The preparation of cranberry or lingonberry or sea buckthorn powder comprises reception, storage and preparation of berry pomace for extraction and supercritical fluid extraction with carbon dioxide (SFE-CO₂).
1. Receiving and storage. Fresh berry pomace after pressing juice is collected and submitted to drying within 2-3 hours after pressing. If immediate drying is not available, the pomace should be frozen and stored in sealed packages at −18° C.
2. Drying. Fresh or defrosted pomace is dried to a moisture content of 7-9% by using various drying methods—hot air (35-40° C., 48-72 hours), freeze-drying (−50° C., 0.5 mbar, 24-48 hours). The dried pomace is cooled, weighed and stored in sealed packages in a well-ventilated room with a relative humidity of no higher than 75% and an ambient temperature not exceeding 20° C. up to 4 months, or refrigerated at 4° C. up to 12 months.
3. Grinding. Before extraction, the required amount of dry pomace is weighed and milled to 0.5-0.75 mm particles. Before milling, mechanical separation of pomace can be additionally carried out by separating the berry seeds in the pomace from the skins and other anatomical parts.
4. Supercritical fluid extraction with carbon dioxide (SFE-CO₂). The weighed amount of milled pomace required for extraction (depends on available extraction equipment) is placed in the extraction vessel of the supercritical fluid extraction system. SFE-CO₂ is carried out at a pressure of 35-55 MPa and a temperature of 40-64° C., for 45-180 min (Table 1) while maintaining the flow rate of food-grade CO₂ gas (99.9% purity) set for the extraction capacity. The duration of static extraction is 10-30 min.

TABLE 1
SFE- CO₂ extraction conditions for various berry pomace

| | | Dietary fiber |
|---|---|---|
| | | rich berry |
| | | pomace |
| | SFE-CO₂ | powder yield** |
| Berry species | parameters* | (g/100 g) |
| Cranberries (Vaccinium oxycoccus; | 53° C., 42.4 MPa, | 88.9 |
| Vaccinium macrocarpon) | 158 min | |
| Sea buckthorn berries (Hippophaë | 60° C., 35 MPa, | 85.4 |
| rhamnoides) | 180 min | |
| Lingonberries (Vaccinium vitis- | 53° C., 47 MPa, | 88.2 |
| idaea) | 75 min | |

*SFE- CO₂ parameters are optimized by using centrally composed rotatable pans and applying surface-response methodology;
**yields determined under laboratory conditions gravimetrically (g/100 g of pomace), may vary depending on raw material.

The collected berry pomace extract, which is the main product of SFE-CO₂, is stored in a dark glass or food-grade metal container at a temperature of 0-4° C. and may be used for various applications as an ingredient for foods, food supplements, cosmetics. The defatted dietary fiber rich berry pomace should be stored in sealed packages in a well-ventilated room with a relative humidity of no higher than 75% and an ambient temperature not exceeding 20° ° C. up to 8 months, or refrigerated at 4° C. up to 16 months.

As an example, Table 2 discloses berry pomace powder (PP) compositions, comprising mainly dietary fiber with smaller amounts of protein, fat, and ash.

TABLE 2
Proximate chemical composition of berry
pomace powder, g/100 g dry matter.

| | | | Sea |
|---|---|---|---|
| Parameters | Cranberry | Lingonberry | buckthorn |
| Moisture | 5.17^{b} ± 0.11 | 3.38^{a} ± 0.03 | 5.25^{b} ± 0.05 |
| Ash | 1.01^{a} ± 0.07 | 1.28^{b} ± 0.01 | 1.53^{c} ± 0.03 |
| Protein (N × 6.25) | 8.5^{a} ± 0.27 | 9.59^{b} ± 0.01 | 25.45^{c} ± 0.41 |
| Fat | 1.67^{a} ± 0.37 | 1.47^{a} ± 0.03 | 1.80^{a} ± 0.20 |
| Total dietary fiber | 77.54^{b} ± 0.65 | 81.36^{b} ± 0.38 | 70.65^{a} ± 0.56 |
| Total insoluble | 63.56^{a}± 1.11 | 71.61^{b} ± 0.35 | 63.93^{a} ± 0.68 |
| dietary fiber: | | | |
| Cellulose | 19.82^{a} ± 1.05 | 20.29^{a} ± 1.08 | 18.64^{a} ± 1.02 |
| Acid insoluble | 40.88^{a} ± 0.45 | 48.15^{b} ± 1.14 | 41.13^{a} ± 1.25 |
| lignin | | | |
| Total soluble dietary | 13.98^{c} ± 0.18 | 9.75^{b} ± 0.03 | 6.72^{a} ± 0.44 |
| fiber | | | |
| Soluble DF/ | 0.22^{c} | 0.14^{b} | 0.11^{a} |
| insoluble DF ratio | | | |
| Carbohydrates* | 11.28^{c} | 6.30^{b} | 0.57^{a} |
| Fe, mg/100 g DM | 7.88 ± 0.04^{c} | 6.20 ± 0.08^{e} | 12.92 ± 0.21^{g} |
| Cu | 5.37 ± 0.05^{c} | 13.11 ± 0.26^{e} | 1.37 ± 0.04^{g} |
| Zn | 5.59 ± 0.01^{c} | 2.85 ± 0.02^{d} | 3.14 ± 0.01^{f} |
| Mn | 15.94 ± 0.18^{c} | 14.80 ± 0.17^{d} | 3.23 ± 0.19^{f} |
| Pb | 0.80 ± 0.04^{c} | 0.97 ± 0.04^{d} | 0.44 ± 0.04^{a} |

*Calculated as 100 − (fat + ash + protein + total dietary fiber)

Exemplary data from Table 2 shows widely varying protein content in the berry PP, from 25.45±0.41 g/100 g DM for sea buckthorn PP to 8.5±0.27 g/100 g DM for cranberry PP. The measured fat content is from 1.47±0.03 to 1.8±0.68 g/100 g DM. The total dietary fiber (TDF) content ranges 70.65±0.56 g/100 g DM in the sea buckthorn PP to 81.36±0.38 g/100 g DM in the lingonberry PP. Table 2 data demonstrates the predominance of insoluble dietary fiber (IDF) in all the berry PP. In the example, most of the IDF consists of cellulose and acid-insoluble lignin. The cellulose content ranges from 18.64±1.02 g/100 g DM in the sea buckthorn PP to 20.29±1.08 g/100 g DM in the lingonberry PP. The acid-insoluble lignin content is approximately 41 g/100 g DM for the sea buckhorn and cranberry PP,48 g/100 g DM for the lingonberry PP. A higher ratio between the soluble dietary fiber (SDF) and IDF can be seen for the cranberry PP (0.22a) and a lower ratio for the lingonberry and sea buckthorn PP (0.14 and 0.11 respectively).

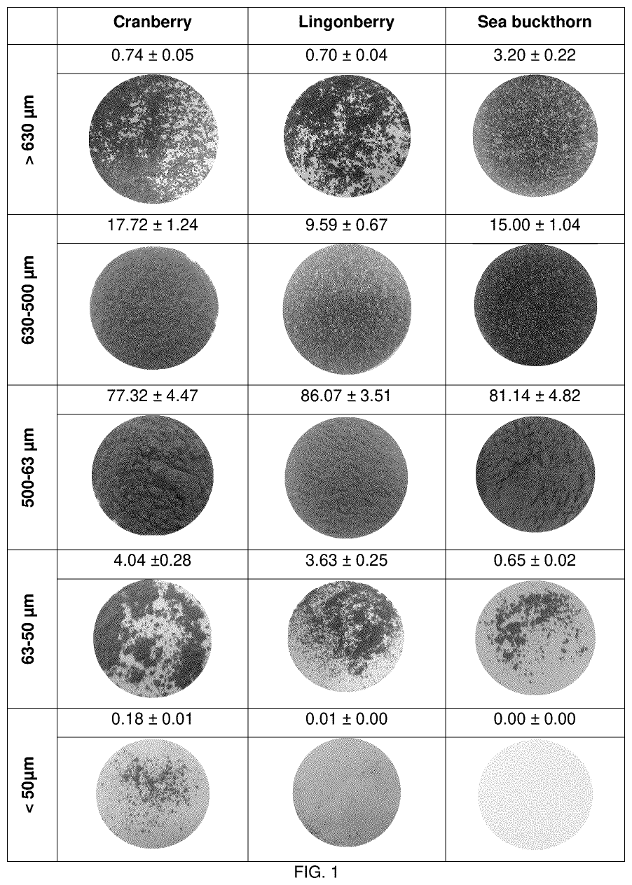

Technological properties of dietary fiber rich berry PP for the PP as described in the example of Tables 3 and 4 comprises particles size distribution (FIG. 1), solubility, water binding capacity, swelling capacity, oil binding capacity, emulsification capability (Table 3).

TABLE 3
Technological properties of berry pomace powder.

| Parameters | Cranberry | Lingonberry | Sea buckthorn |
|---|---|---|---|
| Oil binding | 1.69 ± 0.11 | 2.27 ± 0.02 | 1.63 ± 0.06 |
| capacity, g/g DM | | | |
| Swelling capacity, | 3.30 ± 0.16 | 1.30 ± 0.00 | 2.61 ± 0.46 |
| ml/g DM | | | |
| Water binding | 7.35 ± 0.20 | 5.03 ± 0.20 | 4.67 ± 0.21 |
| capacity, g/g DM | | | |
| Solubility, % | 16.9 ± 0.6 | 19.2 ± 0.05 | 12.1 ± 0.3 |

According to the data of Table 3 of the example of PP, solubility of berry PP is in the range 12.1-19.2%. The water binding capacity and swelling capacity of the berry PP ranges from 4.67 to 7.35 g/g and 1.30 to 3.30 mL/g, respectively. The oil binding capacity of the berry PP ranges from 1.63 to 2.27 g/g and is highest for the lingonberry PP, while the sea buckthorn PP shows the lowest value regarding the oil binding capacity. Capability of berry pomace to stabilize emulsions at room temperature and after heat treatment at 80° C. were dependent on pH and demonstrated best ability to stabilize emulsion at pH 8 as shown in FIG. 2 (cranberry), FIG. 3 (lingonberry), and FIG. 4 (sea buckthorn).

Functional properties of dietary fiber rich berry PP for the cranberry, lingonberry and sea buckthorn PP as described in the example of Table 4 may be reflected in certain physiological effects, such as hypoglycemic and hypolipidemic effects. When berry PP is observed to have good hydration properties, the potential for its use as a food ingredient with a certain functionality can be predicted.

Dietary fibers are capable of binding with bile acids in the small intestine. As a consequence, less bile acids are re-absorbed and more cholesterol is metabolized, in order to compensate for the loss of bile acids and thus reducing cholesterol levels in the blood. Moreover, soluble dietary fibers are reported to directly bind cholesterol in the stomach and small intestine. It was determined that at least cranberry, lingonberry and sea buckthorn PP, bound significantly more (p<0.05) cholesterol at pH 7 compared to pH 2. Among the tested berry pomace, cranberry PP exhibits the highest cholesterol binding capacity (CBC) values: 21.91±0.02 and 23.13±0.47 mg/g at pH 2 and pH 7, respectively. One possible explanation for this could be that cranberry PP contains a higher content of SDF (12.74±0.09 mg/100 g DM) in comparison with other berry pomace, and SDF is reported to be responsible for cholesterol binding (Table 4).

TABLE 4
Cholesterol and sodium cholate binding
capacities of berry pomace powder

| | | | Sodium cholate |
|---|---|---|---|
| | Cholesterol binding | | binding |
| Powder of | capacity, mg/g | | capacity, mg/g |
| pomace | pH 2 | pH 7 | pH 7 |
| Cranberry | 21.91^{b} ± 0.02 | 23.13^{b} ± 0.47 | 52.68^{b} ± 2.07 |
| Lingonberry | 14.16^{c} ± 0.01 | 22.61^{b} ± 0.45 | 40.71^{c} ± 2.78 |
| Sea buckthorn | 15.11^{d} ± 0.06 | 22.75^{b} ± 0.46 | 24.66^{d} ± 5.80 |

^{b,c,d}Different letters among columns indicate significant (p < 0.05).

Most of the body's bile acids exist in the form of sodium cholate. To evaluate the hypolipidemic effect of cranberry, lingonberry and sea buckthorn berry pomace, binding capacity of sodium cholate was measured. At pH 7 sodium cholate binding capacity varied from 24.66 mg/g to 52.68 mg/g, with cranberry PP exhibiting the highest binding capacity.

There are several ways in which the tested berry, i.e. Cranberry, Lingonberry and Sea buckthorn, pomace could reduce the amount of bile salts. One possible way might be due to the gel-forming ability and viscous properties of soluble dietary fibers, that form a gel matrix in which bile acids could be trapped. Furthermore, there are reports indicating that phenolic compounds or particle size of dietary fibers also contribute to the binding of bile acids. Reduction in particle size lead to higher bile acid retardation index values, due to larger specific surface area. Despite high phenolic compounds content sea buckthorn PP exhibited the lowest sodium cholate binding abilities, probably due to containing lowest amount of SDF and smaller particle size. These results indicate that all the tested berry pomace powder can lower the amount of cholesterol and sodium cholate, however, its effectiveness depends on their soluble fibers and phenolic compounds content.

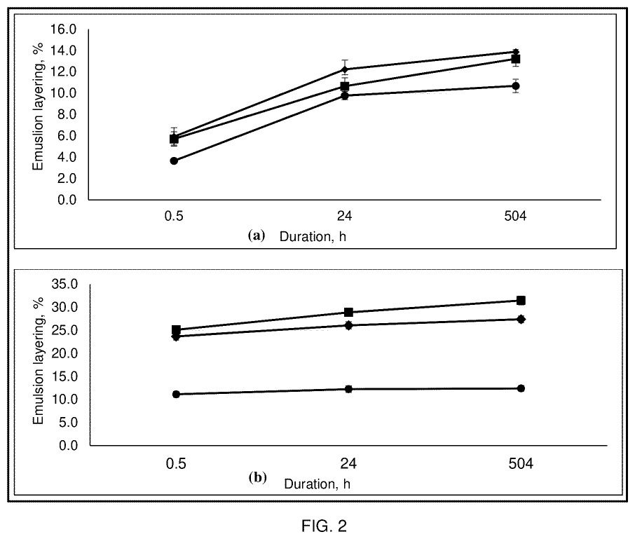

Evaluation of the hypoglycemic effect of the tested berry pomace included determination of glucose adsorption capacity (GAC) and glucose dialysis retardation index (GDRI). There are several mechanisms by which dietary fiber lowers serum glucose level, such as retarding glucose diffusion by increased viscosity or decreasing concentration of available glucose by adsorbing glucose. It was determined that in solutions of low glucose concentration (5 and 10 mmol/L) berry PP did not show the ability to lower glucose concentration (FIG. 5). At higher glucose concentration (50 or 100 mmol/L) all tested berry PP had the ability to reduce glucose concentration in the solution. At the glucose concentration of 100 mmol/L, the amount of glucose adsorbed ranged from 0.542 mmol/g for cranberry PP to 1.291 mmol/g for sea buckthorn PP. This suggests that berry PP can adsorb glucose in the small intestine, thus reducing the contact with intestinal tract and consequently reducing the potential for postprandial hyperglycemia only when there is a higher amount of glucose present.

Glucose dialysis retardation index (GDRI) is an index used to predict the effect of dietary fibers on slowing glucose diffusion. As Table 5 shows, control sample (without berry pomace) displayed considerably higher glucose release at various time intervals in comparison to samples with berry PP. Calculated GDRI values shows, that all tested berry PP were able to retard glucose diffusion across the dialysis membrane compared to control sample. Over time (30 to 180 min), GDRI values decreased. After 30 min, lingonberry PP exhibited the highest GDRI value (27.49%), and after 60, 120 and 180 minutes the same tendencies were seen.

TABLE 5
Effect of berry pomace powders on glucose diffusion
from 30 to 180 min of incubation at 37° C.

| Powder of | Glucose concentration in the dialysate, (mmol/g) | | | |
|---|---|---|---|---|
| pomace | 30 min | 60 min | 120 min | 180 min |
| Control | 1.15^{aA} ± 0.01 | 1.58^{bA} ± 0.02 | 1.98^{cA} ± 0.03 | 2.10^{cA} ± 0.1 |
| Cranberry | 1.03^{aB} ± 0.05 | 1.48^{bB} ± 0.07 | 1.86^{cB} ± 0.09 | 2.05^{cA} ± 0.10 |
| | (10.40) | (6.40) | (5.97) | (2.22) |
| Lingonberry | 0.83^{aC} ± 0.04 | 1.17^{bC} ± 0.06 | 1.62^{cC} ± 0.08 | 1.83^{cB} ± 0.09 |
| | (27.49) | (25.74) | (18.50) | (12.76) |
| Sea buckthorn | 1.00^{aB} ± 0.05 | 1.48^{bB} ± 0.07 | 1.93^{cAB} ± 0.10 | 2.05^{cA} ± 0.10 |
| | (13.30) | (6.13) | (2.49) | (2.23) |

*Data in parentheses present the glucose dialysis retardation indexes of various samples. Different letters among columns indicate significant (p < 0.05) differences (lower case - among time of dialysis; capital letters - among berry PP at the same time of dialysis).

There are several ways in which glucose dialysis can be affected. SDF can slow glucose diffusion mainly due to its viscous properties, while IDF is attributed to adsorption abilities or entrapment of glucose in the network, formed by IDF. Furthermore, phenolic compounds might contribute to the hypoglycemic effects of dietary fiber. Our results suggest, that IDF on glucose retardation was greater compared to SDF, since lingonberry PP containing the highest amount of IDF (65.36%) had the highest GDRI values while cranberry PP with the highest SDF content (12.79 g/100 g D.M.) exhibited lower GDRI values. In addition, high amount of total phenolic content in sea buckthorn PP (13.54 mg GA/g sample) could explain relatively high GDRI values for sea buckthorn PP, even though it contains lower amount of dietary fiber (58.69 and 4.92 g/100 g D.M. for IDF and SDF, respectively), compared to another tested berry PP.

The antioxidant activity of berry pomace was determined using DPPH, ABTS and ORAC methods and results were presented as Trolox equivalents (Table 6).

TABLE 6
Antioxidant properties of berry pomace powder

| Parameters | Cranberry | Lingonberry | Sea buckthorn |
|---|---|---|---|
| Total phenolic | 5.65 ± 0.01 | 11.23 ± 0.09 | 13.54 ± 0.37 |
| content, | | | |
| mg GA/g sample | | | |
| DPPH, mg TE/g | 12.38 ± 0.05 | 20.30 ± 0.90 | 39.16 ± 1.54 |
| sample | | | |
| ABTS, mg TE/g | 44.91 ± 0.74 | 70.53 ± 2.35 | 114.41 ± 4.21 |
| sample | | | |
| ORAC, μmol | 412.20 ± 18.20 | 635.17 ± 21.75 | 838.68 ± 6.30 |
| TE/g sample | | | |

Although the mechanisms of these assays are different (DPPH and ABTS assays are classified as having both electron transfer (ET) and hydrogen atom transfer (HAT) mechanisms, while ORAC is based on HAT mechanism), all three of them indicated that the antioxidant activity decreased in order of lingonberry >cranberry >sea buckthorn and were in line with TPC values. It was observed that berry pomace contains a notable amount of TPC, ranging from 5.65 to 13.54 mg GAE/g sample.

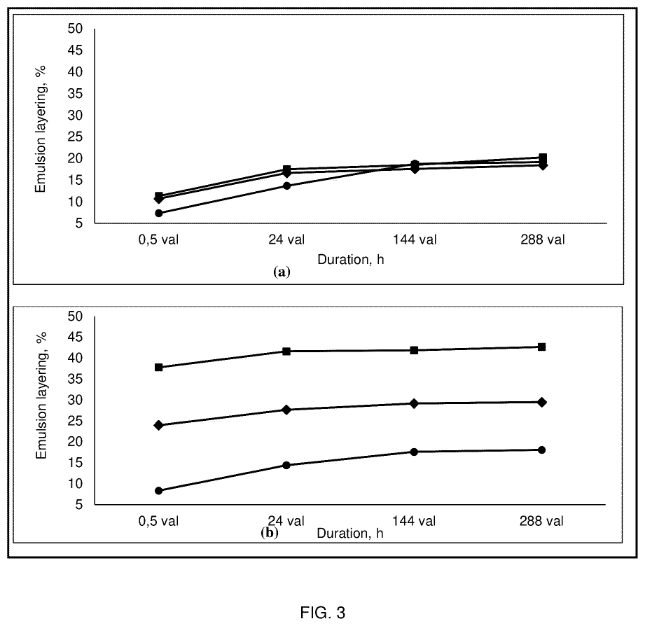

Developing the composition of dietary fiber rich berry pomace powder (PP) of the present invention comprises determining anti-nutritive effect of dietary fiber rich berry PP: whether dietary fiber and phenols rich berry pomace can have an anti-nutritive effect by binding proteins, minerals and vitamins and thus lowering their bioavailability in food products. Dietary fibers have been reported to be able to bind proteins. Moreover, plant phenols could bind with proteins as well. These interactions could have a detrimental effect on protein structure or functionality, as well as loss of nutritional value. Our results of the berry PP protein binding capacity are expressed as free a-amino group binding capacity (FIG. 6). They indicate that after incubation with bovine serum albumin solution the tested pomace powder did not lower the amount of proteins in the solution, but instead increased it. Among the tested berry pomace, sea buckthorn PP increased the concentration of α-amino groups in the solution the most, and these results are in line with the protein composition of berry pomace.

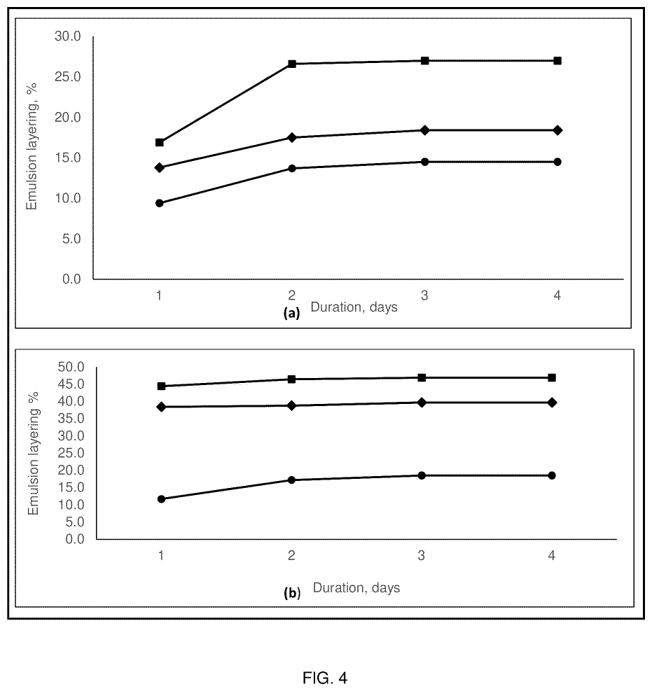

The ability of the tested berry PP to bind vitamins C and B9 is shown in FIG. 7. The tested berry PP showed a strong ability to bind vitamin C. Sea buckthorn PP bound the highest amount of vitamin C (94.65%, at pH 7) while cranberry PP exhibited the lowest binding ability (76.30%, at pH 7). Furthermore, there were no significant differences (p<0.05) in vitamin C binding properties in acidic and alkaline solutions. Compared to vitamin C binding capacity, vitamin B9 binding was determined considerably lower, with binding values ranging from 38.46% (for cranberry PP) to 69.23% (for lingonberry and sea buckthorn PP).

Metal ion sorption by dietary fiber can occur through chemical, physical or mechanical sorption. Chemisorption occurs mainly through active functional groups and are linked to the presence of lignin and uronic acids, the former containing phenolic groups while the latter carboxyl groups. In addition, physical and mechanical sorption happens due to van der Waal's force and porosity, respectively.

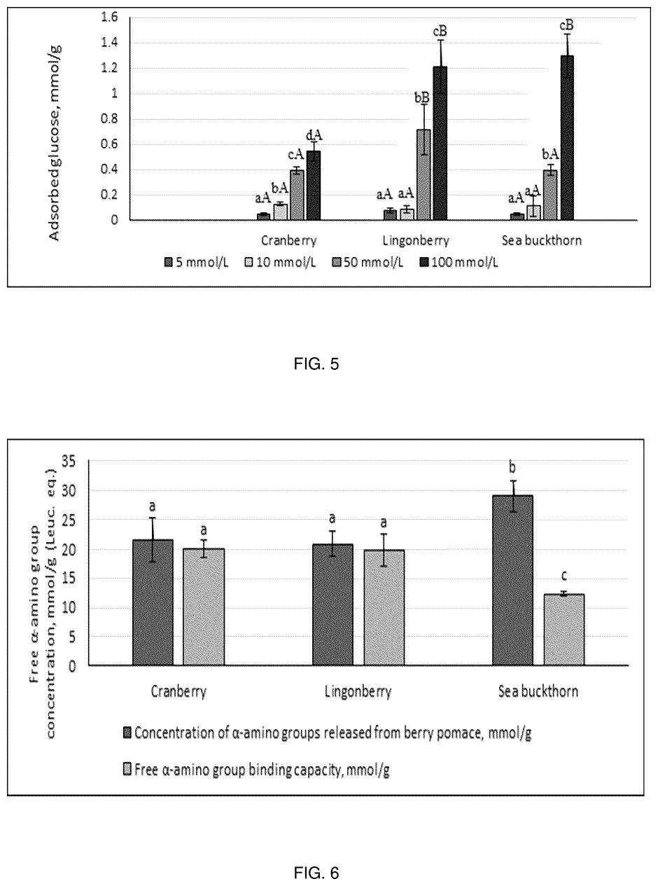

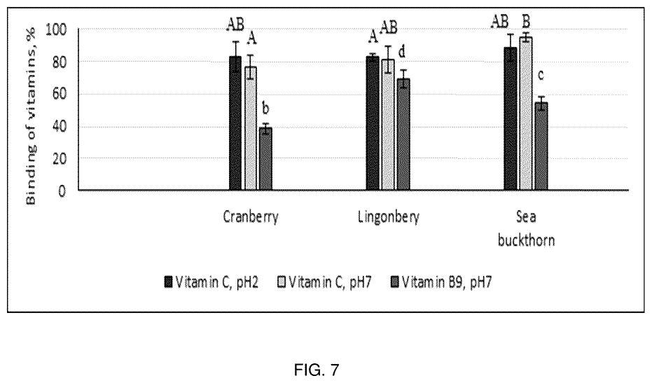

All tested dietary fiber rich berry PP had zinc and selenium binding abilities and with increasing mineral concentration in the solution, binding ability of berry pomace increased as well (FIG. 8). Furthermore, zinc binding capacity showed that at pH 7 binding of zinc ions was significantly greater than at pH 2 and this could be explained by dissociation of carboxyl groups, due to which the chemisorption of cations increased. However, the results of selenium binding capacity revealed that the increase in pH did not have as much effect as in zinc binding and this could indicate that chemisorption was not dominant in selenium ions binding. Fourier Transform—Infrared Spectroscopy (FT-IR) analysis was performed to determine if chemical adsorption in Se binding was occurring. The FT-IR spectra of berry pomace (BP) and mixtures of BP with selenium (BP—Se) at different pH are shown in FIG. 9. All tested samples were found to have strong absorption band maximums (ABₘₐₓ) at approximately 3400, 2925 and 1745 cm⁻¹, the first ABₘₐₓ indicating the presence of hydroxyl groups (since it was followed by spectra in the regions 1600-1300, 1200-1000 and 800-600 cm⁻¹ [140]), while others are characteristic of C—H stretching vibrations and carbonyl compounds, respectively. The region from 600 to 1500 cm 1 is the fingerprint region, which is unique for each organic compound.

Berry pomace is a complex of polysaccharides, proteins and phenolic compounds, and due to this, identification of some adsorption bands is difficult. For example, a ABₘₐₓ at ≈1630 cm⁻¹ could indicate amide or a slightly shifted carboxylate ion (COO—) group. FT-IR absorption peak of pectin samples at 1745 cm⁻¹ corresponds to the double bond of methyl ester group and carboxylic acid, while the absorption maxima at 1610 cm⁻¹ indicate vibrations of carboxylate ions. In addition to that, the maximum absorption band of COO—is located in the region of 1550-1620 cm⁻¹. Since berry pomace contains relatively high amount of pectin, it is likely that the absorption maxima at ≈1630 cm⁻¹ could be COO—. Another possibility is that due to the peptide linkages in the pomace protein, this maximum absorption indicates the presence of amide group, which is reported to be in the 1600-1700 cm⁻¹ region. The absorption bands in the fingerprint region corresponds to C—H, C—O and C—C bonds vibration.

Polyvalent cations interact with polysaccharides, proteins and phenolic compounds mostly through C═O functional groups (e.g., carboxylic acids, aldehydes, ketones, carboxylate ions or amides). Due to this interaction, the binding strength changes in the double bond and this causes the absorption maximum in the FT-IR spectrum to shift. The present study demonstrated the changes in the absorption maximums of the FT-IR spectra (Table 7).

TABLE 7
Shifts of the O—H, C═O and COO— absorption
band maximums in FTIR spectra of tested berry pomace
powders mixture with Se, compared to FTIR of berry pomace powders

| | | O—H | C=O | COO— |
|---|---|---|---|---|
| CP | pH 3 | −8.45 | 0.86 | −3.06 |
| | pH 7 | −1.03 | 0.6 | 1.57 |
| LP | pH 3 | −12.02 | 3.3 | 11.68 |
| | pH 7 | −9.28 | 1.12 | −1.7 |
| SP | pH 3 | −5.53 | 0.27 | −7.55 |
| | pH 7 | −9.19 | 0.91 | 11.73 |

The results show that the FT-IR absorption maximums indicating hydroxyl groups have significantly shifted toward lower wave numbers for all tested berry PP except cranberry PP at pH 7, for which the shift was insignificant. Furthermore, the maximum of absorption peak indicating COO—shifted considerably for sea buckthorn PP at pH 3 and 7 and for lingonberry PP at pH 3. These shifts in absorption band maximum confirms that chemisorption is involved in metal ions binding.

Retention of functionality of dietary fibers rich berry PP in different parts of the digestive tract. Our results allow us to predict the potential of dietary fibers rich berry PP as functional ingredient in food products due to good hypoglycemic and hypolipidemic effect and high antioxidant activity. In order to confirm this assumption, we determined changes in antioxidant activity of berry PP during digestion process. We also evaluated how the dietary fibers rich berry PP release polyphenolic compounds during digestion, since it is precisely these compounds that give them their antioxidant activity to a large extent.

The digestibility results of the berry PP revealed that as the in vitro digestion progressed, the overall release of total phenolic compounds (TPC) increased (Table 8).

TABLE 8
Dynamics total phenolic content release from berry pomace and
changes in antioxidant activity during static in vitro digestion;
different lower case letters indicate significant (p <
0.05) differences among berry pomace at different digestion
phase; different capital letters indicate significant (p <
0.05) differences among berry pomace at different digestion phase.

| | | | Sea buckthorn |
|---|---|---|---|
| | Cranberry PP | Lingonberry PP | PP |
| | Total phenolic content, mg GAE/g DM | | |
| Before digestion | 4.22 ± 0.29^{bA} | 6.71 ± 0.23^{dA} | 6.24 ± 0.02^{eA} |
| Post-gastric | 4.24 ± 0.26^{bA} | 6.92 ± 0.37^{dA} | 8.27 ± 0.30^{eB} |
| Post-intestinal | 8.30 ± 0.17^{cB} | 10.75 ± 0.08^{eB} | 10.57 ± 0.02^{gC} |
| | DPPH, μmol TE/g DM | | |
| Post-gastric | 4.79 ± 0.25^{cA} | 12.51 ± 0.34^{bA} | 3.76 ± 0.54^{dA} |
| Post-intestinal | 30.20 ± 0.32^{cB} | 16.65 ± 0.80^{dB} | 5.63 ± 0.30^{fB} |
| | ABTS, μmol TE/g DM | | |
| Post-gastric | 60.56 ± 3.37^{cA} | 46.67 ± 1.20^{aA} | 14.69 ± 0.88^{dA} |
| Post-intestinal | 158.35 ± 2.92^{cB} | 69.57 ± 4.97^{eB} | 34.77 ± 0.96^{dB} |
| | ORAC, μmol TE/g DM | | |
| Post-gastric | 20.65 ± 1.26^{bA} | 47.27 ± 2.68^{dA} | 59.46 ± 0.67^{eA} |
| Post-intestinal | 301.79 ± 7.52^{cB} | 56.01 ± 2.14^{dB} | 72.38 ± 0.24^{fB} |

Post-gastric total phenolic content (TPC) was significantly (p<0.05) higher than at the beginning of the digestion, and the values ranged from 4.24 mg GAE/g DM (for cranberry PP) to 8.27±0.30 mg GAE/g DM (for sea buckthorn PP). After the intestinal digestion phase, TPC was determined significantly (p<0.05) higher than in the post-gastric phase for all tested berry. The increase in TPC can be explained by bound phenolics release from cell wall components during digestion procedure. Furthermore, berry PP contains proteins that could interact with phenolic compounds increasing their stability during digestion procedure.

To get a better picture of antioxidative properties, it is recommended to use more than one antioxidant assay; therefore, the antioxidant activity of berry PP digesta was investigated using 2,2-diphenyl-1-picrylhydrazyl (DPPH), 2,2′-azino-bis(3-ethylbenzothiazoline-6-sulfonic acid (ABTS) and Oxygen Radical Absorbance Capacity (ORAC) methods. As shown in Table 8, all tested berry PP had the ability to scavenge DPPH radicals. In the post-gastric phase, the DPPH scavenging activity ranged from 3.76 μmol TE/1 g DM (for sea buckthorn PP) to 12.51 μmol TE/1 g DM (for lingonberry PP), and at the end of the intestinal phase, a significant increase (p<0.05) in the DPPH scavenging activity was observed for all pomace, ranging from 5.63 μmol TE/1 g DM (for SP) to 30.20 μmol TE/1 g DM (for CP). In the intestinal digestion phase, alkaline pH conditions have been reported to improve the scavenging ability of phenols, and this could be the reason why better scavenging capacity was determined at the end of the intestinal phase. ABTS radical scavenging capacity and ORAC assay analysis of berry PP digesta revealed similar trend to DPPH assay results, were compared to post-gastric digestion phase, a significantly (p<0.05) higher values of the ABTS radical scavenging capacity and ORAC were determined in the post-intestinal phase. At the end of intestinal digestion, CP showed the highest ORAC values (301.79 μmol TE/g DM). Overall, these results suggest that even after in vitro digestion, all berry PP maintained their ability to act as antioxidants.

According to one embodiment of the invention, the tested dietary fiber rich berry PP are incorporated in yogurt. Cranberry, lingonberry and sea buckhorn pomace powders comprising at least 70 g/100 g d.m. of dietary fiber with soluble and insoluble dietary fiber ratio 0.2 are effective in water binding, swallowing and oil binding capacity.

The effect of adding dietary fiber-rich cranberry pomace powders (CP) before or after fermentation on the properties of yogurt. In this study different amounts (from 2% to 4.5%) of dietary fiber-rich cranberry pomace powders (CPP) were added to yogurt before or after fermentation. The effect of adding dietary fiber-rich CPP on the physicochemical, rheological, and antioxidant properties and the bacterial viability of yogurt was evaluated.

The proximate chemical composition of yogurt made with CPP showed that the addition of 2% CPP increased dietary fiber content by approximately 1.45%, while the addition of 4.5% CP increased the content of dietary fiber by approximately 3.27% compared with plain yogurt (Table 9).

TABLE 9
Chemical composition (g/100 g) of yogurt
made with different amount of CPP

| | | | | | | |
|---|---|---|---|---|---|---|
| | | | | Soluble | Insoluble | Total |
| Sample | Fat | Protein | Fiber | fiber | fiber | solids |

Yogurt with CP

| | | | | | | |
|---|---|---|---|---|---|---|
| CP_0 | 0.00 | 5.68 | 0.00 | 0.00 | 0.00 | 13.84 |
| CP_2 | 0.20 | 5.83 | 1.45 | 0.25 | 1.20 | 15.66 |
| CP_3 | 0.29 | 5.90 | 2.18 | 0.38 | 1.80 | 16.56 |
| CP_4.5 | 0.44 | 6.01 | 3.27 | 0.57 | 2.70 | 17.92 |

Therefore, yogurt made with 4.5% CP could be claimed as “a source of fiber” or “containing fiber”. This yogurt formulation fulfills the European Food Safety Authority (EFSA) requirement for nutrient claims of having at least 3 g/100 g of dietary fiber (Reglament 1924).

In general, it can be stated, that yogurt enriched with the highest amount of CPP (4.5%) had better syneresis properties, was more viscous, had a larger particle size compared to other yogurt products enriched with a lower amount of CPP (0-3%) as shown in FIG. 15 and Table 10.

TABLE 10
Physicochemical and rheological properties of yogurt made by adding different
amount of CPP after (I method) and before fermentation (II method)

| CPP | | | | | | |
|---|---|---|---|---|---|---|
| content in | Rheological characteristics from flow curves and mechanical spectra³ | | | | | Average particle |
| yogurt, % | τ₀¹, Pa | K¹(Pa sⁿ) | G′², Pa | tanδ² | Syneresis, % | size, D 4.3 (nm) |
| 0 | 12.95 ± 0.30a | 0.12 ± 0.00a | 138 ± 18.08a | 0.30 ± 0.00a | 24 ± 2a | 59.14 ± 0.86a |
| | I method | | | | | |
| 2 | 19.53± 1.48bA | 0.17 ± 0.00bA | 225 ± 11.72bcA | 0.31 ± 0.00aA | 13 ± 3bA | 58.35 ± 4.68abA |
| 3 | 20.90 ± 3.07bcA | 0.20 ± 0.00cdA | 261 ± 5.29cA | 0.33 ± 0.01bA | 11 ± 2cdA | 72.94 ± 3.80bA |
| 4.5 | 24.32 ± 1.46cA | 0.22 ± 0.02dA | 348 ± 19.01dA | 0.34 ± 0.00bA | 9 ± 1dA | 101.02 ± 10.83cA |
| | II method | | | | | |
| 2 | 15.30 ± 0.10bB | 0.17 ± 0.02bA | 233 ± 17.39bA | 0.33 ± 0.00bB | 12 ± 2bA | 67.94 ± 2.69bA |
| 3 | 18.96 ± 0.96cA | 0.18 ± 0.02bcA | 283 ± 17.44cdA | 0.34 ± 0.00bcA | 7 ± 3cB | 77.42 ± 2.94cA |
| 4.5 | 36.16 ± 0.85dB | 0.29 ± 0.00cB | 419 ± 8.08dB | 0.37 ± 0.01cB | 6 ± 1cB | 113.27 ± 7.47dB |

¹yield stress (τ₀) and consistency index (K) calculated using Bingham model;
²storage modulus (G′) and loss tangent (tanδ) at angular frequency of 25 1/s
³values are reported as means ± standard deviation; lower case letters indicate significant (p < 0.05) differences between different CP content in yogurt; upper case letters indicate significant (p < 0.05) differences between different CP addition method.

In more detail, incorporating CPP into the yogurt structure significantly (p<0.05) reduced the amount of whey separation. The CP-fortified yogurt with 4.5% CP added before fermentation held more whey than the CP-fortified yogurt with the same amount of CP added after fermentation. Syneresis occurs due to the inability of the yogurt gel to retain the serum phase because of weakening of the casein network and leads to the release of whey. The increase in CPP content positively influences the network density and reduces the syneresis of fermented milk due to the good hydration properties of CPP (water binding capacity and swelling).

The incorporation of CPP significantly increased the viscosity of the yogurt in comparison with the plain yogurt. The addition of 2.0%-4.5% CP after the fermentation of the yogurt moderately increased the yield stress (To) and the consistency index (K) from 12.95±0.3 to 24.32±1.46 Pa and from 0.12±0.00 to 0.22±0.02 Pa sⁿ, respectively (Table 10). When the CP was added to the yogurt before fermentation, significantly higher values of the yield stress (Tₒ) and the consistency index (K) were recorded for the samples containing higher amounts of CP. The highest rheological characteristic values were determined when 4.5% CP was added to the yogurt before fermentation; To was 36.16±0.85 Pa, and K was 0.29±0.00 Pa sⁿ. These results indicate enhanced network formation when more CPP was added.

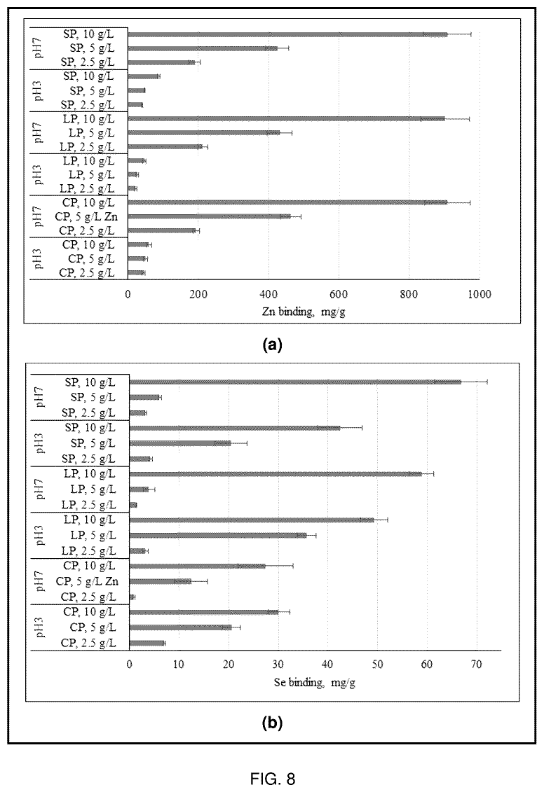

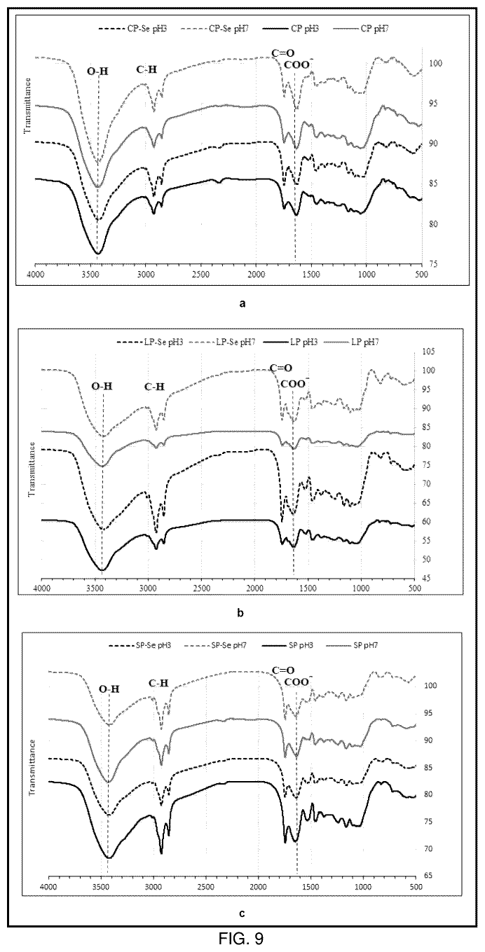

The changes in yogurt structural properties were related not only to the fiber content but also to the particle size of the fiber. Our data about the particle size distribution in yogurt (FIG. 10) describes yogurt as a network of aggregated casein particles with larger CPP particles dispersed in it. The plain yogurt samples showed a monomodal particle size distribution between ˜5.0 and ˜200.0 nm, while a bimodal particle size distribution was observed for the CPP-supplemented yogurt. The shape of this bimodal curve was dependent on the timing of the CPP addition. In the case of yogurt supplemented with CPP after fermentation, most of the particle sizes were in the range 3.0-138.0 nm, and only a small number of them were in the range 140.0-1250.0 nm. Increasing the amount of added CPP caused an increase in the height of the second peak, representing CPP particles, and had a very slight effect on the height of the first peak, representing aggregated casein particles. In the case of yogurt supplemented with CPP before fermentation, the first peak was in the range 3.0-160.0 nm and depended on the amount of added CPP; the height of the first peak decreased with increasing amounts of added CPP. Although the curve also had two peaks, in this case, the separation between the peaks is not as clear as in the first case. The second peak showed the distribution of particles in the interval 180.0-2200.0 nm and was also dependent on the amount of added CPP. It can be assumed that adding CPP to the system before the casein network formed invoked the complexation between milk proteins and polysaccharides from CPP, which drove the more intensive formation of larger particles in the structure of yogurt. Micrographs of the yogurts also showed the differences in the CP-fortified yogurt structure, particularly for high CP content (FIG. 11). A typical casein aggregate-based network with open spaces was recorded for the plain yogurt. The microstructure of the CPP-supplemented yogurt was different from that of plain yogurt and depended on the timing of the CPP addition. The yogurt with CPP added after fermentation consisted of a three-dimensional network of casein aggregates with larger pores and heterogeneously sized channels with the CPP fiber located within these void spaces. The yogurt with CPP added before fermentation demonstrated two heterogeneously blended networks: a rough appearance representing CPP fiber and another more compact protein network, which seemed to be embedded into the first one.

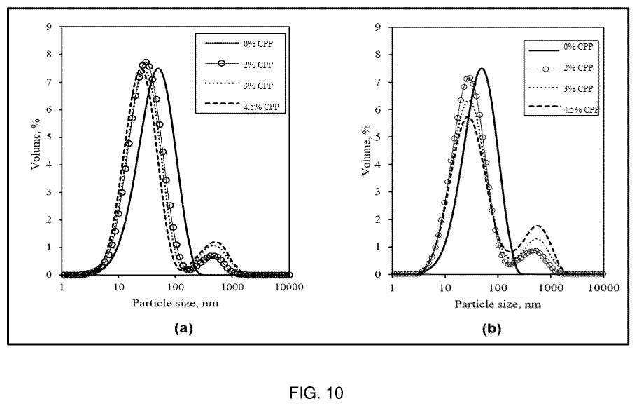

An appropriate concentration of viable LAB bacteria is especially important in the yogurt fortified by CPP due to claims about the antimicrobial properties of cranberries Our study demonstrated that adding CPP after fermentation slightly increased the number of LAB cultures compared with the plain yogurt (FIG. 12). When CPP was added before fermentation, a modest decrease in LAB viability was detected compared to the control yogurt. The increased amounts of added CPP had no significant effect on the LAB viability in both cases. It is very important that yogurt fortified with CPP has a higher concentration of viable LAB than that required by the Codex Alimentarius (10⁷ CFU/g).

According to the data presented in Table 11, in yogurt the metabolites of LAB fermentation, such as organic acids, low molecular weight peptides, glutathione, and folate, contribute to the antioxidant potential of CPP-fortified yogurt along with the phenol compounds and organic acids of CPP. In general, all antioxidant capacity values increased with CPP in a dose-dependent manner, independent of the stage at which the CP was added.

TABLE 11
Total phenols content and antioxidant capacity of yogurt made by adding different
amount of CP after (I method) and before fermentation (II method)

| | Total phenols | | | |
|---|---|---|---|---|
| CPP | content, | Antioxidant activity | | |
| content in | μg GAE/g | DPPH, μM | ABTS, μM | ORAC, μM TE/g |
| yogurt, % | sample | TE/g DW | TE/g DW | DW |
| 0 | 62.67 ± 2.73aA | 1.74 ± 0.20aA | 10.03 ± 1.12aA | 16.67 ± 1.25aA |
| | I method | | | |
| 2 | 125.20 ± 2.84bA | 3.44 ± 0.90bA | 19.13 ± 2.89bA | 46.39 ± 2.30bA |
| 3 | 138.40 ± 2.57cA | 3.98 ± 0.51bA | 22.44 ± 1.02cA | 47.01 ± 1.41bA |
| 4.5 | 188.95 ± 1.84dA | 3.46 ± 0.47bA | 20.96 ± 1.89cA | 53.54 ± 0.04cA |
| | II method | | | |
| 2 | 118.59 ± 0.14bB | 3.57 ± 0.72bA | 20.16 ± 0.72bA | 24.78 ± 0.99bB |
| 3 | 139.09 ± 3.39cA | 3.74 ± 0.17bA | 24.37 ± 1.36cB | 34.36 ± 2.56cB |
| 4.5 | 167.39 ± 0.42dB | 4.01 ± 0.63bA | 28.76 ± 1.26dB | 36.02 ± 0.91dB |

Values are reported as means ± standard deviation; lower case letters indicate significant (p < 0.05) differences between different CPP content in yogurt; upper case letters indicate significant (p < 0.05) differences between different CPP addition method

Stability of yogurt made by adding dietary fiber-rich cranberry pomace powders (CP) after (I method) or before (II method) fermentation. Since the addition of CPP to yogurt changes its structural properties, viscosity, whey release, viability of LAB bacteria and antioxidant activity, it is important to determine whether these changes have an impact on product shelf life. For this purpose, we aimed to evaluate changes in the physicochemical, structural properties, antioxidant activity and viability of LAB of yogurt enriched with different amounts of CPP during storage for 28 days, when CPP was added before and after yogurt fermentation.

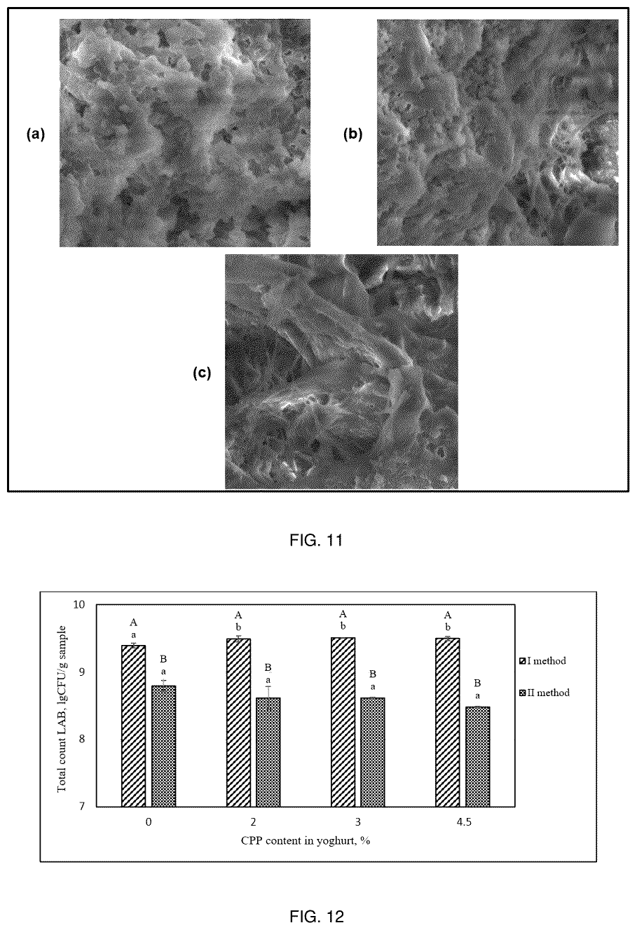

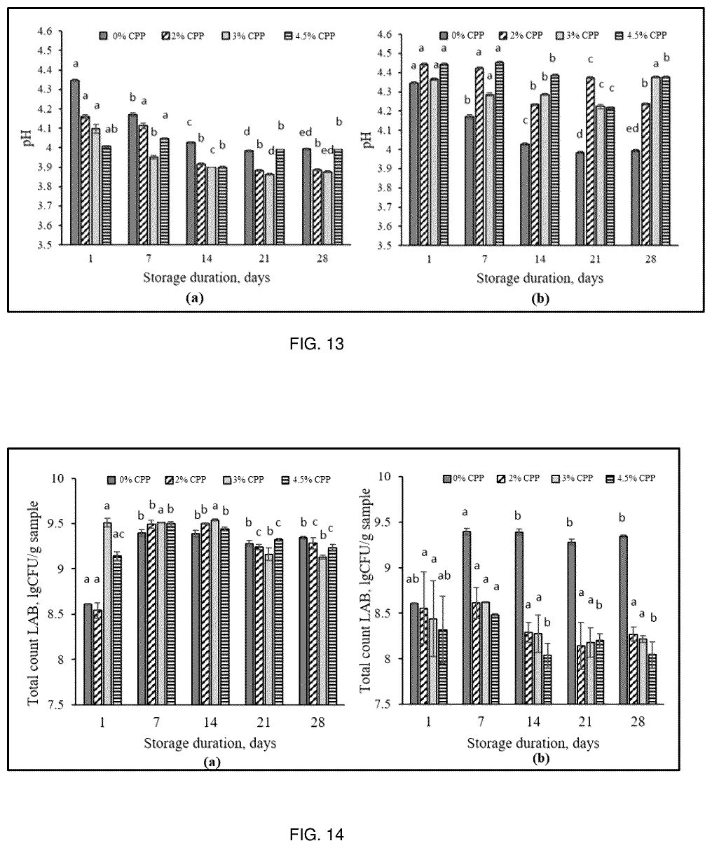

Irrespective of the stage of CPP addition, the yogurt remained relatively stable throughout storage for 28 days; the addition of CPP ensured unchanged rheological properties, particle size, lactic acid bacteria count, total phenolic content and antioxidant activity. In more detail, the pH values of yogurt decreased moderately during the storage period due to the activity of LAB, which releases acidic metabolites (FIG. 13). During the first 7 days of storage, the amount of LAB in all samples increased and then slowly decreased (FIG. 14). It is important that in yogurt made with CPP added before or after fermentation LAB remained viable throughout storage period and their total amount was higher than that required by the Codex Alimentarius standard (at least 10⁷ CFU/g).

The addition of CPP to yogurt significantly reduced the release of whey during the entire storage period (28 days), compared to the plain yogurt (Table 12). The values of the loss tangent (tan δ) during the storage of yogurts (28 days) remained stable in all yogurt samples produced by adding CPP before or after fermentation (Table 12).

TABLE 12
Viscoelastic characteristics of yogurt made by adding
different amount of CPP during storage (28 days).

| CPP | Storage duration, days | | | | | | | | | |
|---|---|---|---|---|---|---|---|---|---|---|
| amount in | 1 | 7 | 14 | 21 | 28 | 1 | 7 | 14 | 21 | 28 |
| yogurt, % | tanδ | | | | | G′ (Pa) | | | | |
| 0 | 0.30 ± | 0.30 ± | 0.29 ± | 0.29 ± | 0.29 ± | 159 ± | 138 ± | 184 ± | 176 ± | 219 ± |
| | 0.00a | 0.00a | 0.011a | 0.01a | 0.01a | 4a | 18a | 19ab | 1ab | 16b |

Yogurt made by adding CPP after fermentation (I method)

| | | | | | | | | | | |
|---|---|---|---|---|---|---|---|---|---|---|
| 2 | 0.32 ± | 0.31 ± | 0.30 ± | 0.30 ± | 0.30 ± | 218 ± | 225 ± | 275 ± | 248 ± | 280 ± |
| | 0.01a | 0.00a | 0.01a | 0.01a | 0.00a | 8a | 12ab | 3b | 8b | 21b |
| 3 | 0.33 ± | 0.33 ± | 0.32 ± | 0.31 ± | 0.31 ± | 255 ± | 261 ± | 306 ± | 360 ± | 361 ± |
| | 0.01a | 0.01a | 0.01a | 0.01a | 0.00a | 1a | 5a | 11b | 15b | 17b |
| 4.5 | 0.34 ± | 0.34 ± | 0.34 ± | 0.33 ± | 0.32 ± | 367 ± | 348 ± | 369 ± | 393 ± | 445 ± |
| | 0.00a | 0.00a | 0.00a | 0.01a | 0.01a | 6a | 19a | 20a | 17a | 13b |

Yogurt produced by adding CPP before fermentation (II method)

| | | | | | | | | | | |
|---|---|---|---|---|---|---|---|---|---|---|
| 2 | 0.33 ± | 0.33 ± | 0.30 ± | 0.31 ± | 0.32 ± | 188 ± | 233 ± | 262 ± | 255 ± | 265 ± |
| | 0.01a | 0.00a | 0.01a | 0.01a | 0.01a | 4a | 17b | 3b | 19b | 13b |
| 3 | 0.34 ± | 0.34 ± | 0.33 ± | 0.33 ± | 0.33 ± | 297 ± | 283 ± | 295 ± | 306 ± | 338 ± |
| | 0.01a | 0.00a | 0.01a | 0.01a | 0.01a | 14a | 17a | 14a | 1a | 11b |
| 4.5 | 0.37 ± | 0.37 ± | 0.34 ± | 0.35 ± | 0.33 ± | 386 ± | 419 ± | 410 ± | 544 ± | 523 ± |
| | 0.01a | 0.01a | 0.01a | 0.01a | 0.01a | 1a | 8b | 4b | 4c | 17c |

Different letters indicate significant (p < 0.05) differences between values at different storage period.

The recorded changes are slight and statistically insignificant (p>0.05). Different results were found when evaluating the modulus of elasticity (G′) of CPP-enriched yogurt samples. During storage up to day 14, G′ values of all samples increased statistically significantly (p<0.05), and during further storage, G′ values stabilized. These results indicated that yogurt gels firm up during storage due to the CPP ability to bind water and form bonds with proteins.

Analysis of antioxidant activity of CPP-enriched yogurt samples during the entire storage period showed that, regardless of the amount and method CPP addition, the antioxidant activity of the products did nor decrease significantly (Table 13).

TABLE 13
Antioxidant activity of yogurt made by adding different amount of CPP during
storage (28 days). A1 - yogurt made by adding CPP after fermentation (I method);
A2 - yogurt produced by adding CPP before fermentation (II method).

| CPP | I method | | | | | II method | | | | |
|---|---|---|---|---|---|---|---|---|---|---|
| amount in | Storage duration, days | | | | | | | | | |
| yogurt,% | 1 | 7 | 14 | 21 | 28 | 1 | 7 | 14 | 21 | 28 |
| | DPPH, μM TE/g D.M. | | | | | | | | | |
| 0 | 1.15 ± | 1.74 ± | 1.44 ± | 1.59 ± | 1.44 ± | 1.15 ± | 1.74 ± | 1.44 ± | 1.59 ± | 1.44 ± |
| | 0.41^{a} | 0.20^{a} | 0.00^{a} | 0.20^{a} | 0.41^{a} | 0.41^{a} | 0.20^{a} | 0.00^{a} | 0.20^{a} | 0.41^{a} |
| 2 | 2.74 ± | 3.44 ± | 3.95 ± | 2.93 ± | 2.81 ± | 3.61 ± | 3.57 ± | 3.19 ± | 3.32 ± | 3.32 ± |
| | 0.20^{a} | 0.90^{a} | 0.54^{a} | 0.54^{a} | 0.36^{a} | 0.20^{a} | 0.72^{a} | 0.18^{a} | 0.00^{a} | 0.00^{a} |
| 3 | 4.76 ± | 3.98 ± | 4.34 ± | 3.98 ± | 3.98 ± | 4.47 ± | 3.74 ± | 4.22 ± | 4.34 ± | 3.98 ± |
| | 0.20^{a} | 0.51^{a} | 0.34^{a} | 0.17^{a} | 0.17^{a} | 0.61^{a} | 0.17^{a} | 0.51^{a} | 0.34^{a} | 0.51^{a} |
| 4.5 | 6.21 ± | 3.46 ± | 4.24 ± | 4.35 ± | 4.68 ± | 5.92 ± | 4.01 ± | 4.35 ± | 5.24 ± | 4.91 ± |
| | 0.20^{a} | 0.47^{b} | 0.32^{b} | 0.47^{b} | 0.63^{b} | 0.61^{a} | 0.63^{b} | 0.16^{ab} | 0.16^{a} | 0.63^{ab} |
| | ORAC, μM TE/g D.M. | | | | | | | | | |
| 0 | 19.80 ± | 16.67 ± | 25.25 ± | 28.58 ± | 26.99 ± | 19.80 ± | 16.67 ± | 25.25 ± | 28.58 ± | 26.99 ± |
| | 0.61^{a} | 1.25^{a} | 0.97^{b} | 0.56^{b} | 1.18^{b} | 0.61^{a} | 1.25^{a} | 0.97^{b} | 0.56^{b} | 1.18^{b} |
| 2 | 30.43 ± | 46.39 ± | 47.83 ± | 45.95 ± | 47.89 ± | 27.23 ± | 24.78 ± | 23.95 ± | 24.01 ± | 29.63 ± |
| | 0.41^{a} | 2.30^{b} | 1.81^{b} | 0.68^{b} | 0.72^{b} | 2.75^{ab} | 0.99^{a} | 0.63^{a} | 0.54^{a} | 0.36^{b} |
| 3 | 37.80 ± | 47.01 ± | 47.01 ± | 48.46 ± | 54.86 ± | 30.13 ± | 34.36 ± | 33.57 ± | 35.87 ± | 36.08 ± |
| | 0.51^{a} | 1.41^{b} | 0.90^{b} | 1.58^{b} | 0.98^{c} | 0.68^{a} | 2.56^{ab} | 2.05^{ab} | 1.37^{ab} | 0.38^{b} |
| 4.5 | 43.92 ± | 53.54 ± | 48.86 ± | 51.79 ± | 57.06 ± | 32.78 ± | 36.02 ± | 38.00 ± | 39.06 ± | 39.62 ± |
| | 2.13^{a} | 0.04^{b} | 1.62^{ab} | 0.63^{b} | 0.99^{c} | 1.62^{a} | 0.91^{a} | 0.87^{a} | 0.79^{b} | 2.37^{b} |
| | ABTS, μM TE/g D.M. | | | | | | | | | |
| 0 | 9.96 ± | 10.03 ± | 11.84 ± | 13.42 ± | 14.15 ± | 9.96 ± | 10.03 ± | 11.84 ± | 13.42 ± | 14.15 ± |
| | 0.20^{a} | 1.12^{ab} | 0.41^{b} | 0.61^{bc} | 0.41^{c} | 0.20^{a} | 1.12^{ab} | 0.41^{b} | 0.61^{bc} | 0.41^{c} |
| 2 | 16.46 ± | 19.13 ± | 19.77 ± | 20.03 ± | 22.07 ± | 17.22 ± | 20.16 ± | 22.32 ± | 22.58 ± | 25.64 ± |
| | 0.54^{a} | 2.89^{ab} | 0.18^{ab} | 0.54^{b} | 0.90^{b} | 0.54^{a} | 0.72^{b} | 0.18^{b} | 0.90^{b} | 0.54^{c} |
| 3 | 19.18 ± | 22.44 ± | 24.25 ± | 23.89 ± | 24.37 ± | 23.40 ± | 24.37 ± | 25.45 ± | 26.06 ± | 29.43 ± |
| | 0.51^{a} | 1.02^{a} | 0.51^{b} | 0.68^{b} | 0.68^{b} | 0.68^{a} | 1.36^{ab} | 1.5^{ab} | 0.34^{b} | 1.02^{c} |
| 4.5 | 20.96 ± | 20.96 ± | 24.64 ± | 25.08 ± | 27.87 ± | 26.53 ± | 28.76 ± | 30.43 ± | 30.32 ± | 30.43 ± |
| | 1.58^{a} | 1.89^{a} | 1.10^{b} | 1.42^{b} | 0.95^{b} | 0.63^{a} | 1.26^{ab} | 0.47^{b} | 0.32^{b} | 0.79^{b} |

Different letters indicate significant (p < 0.05) differences between values at different storage period.

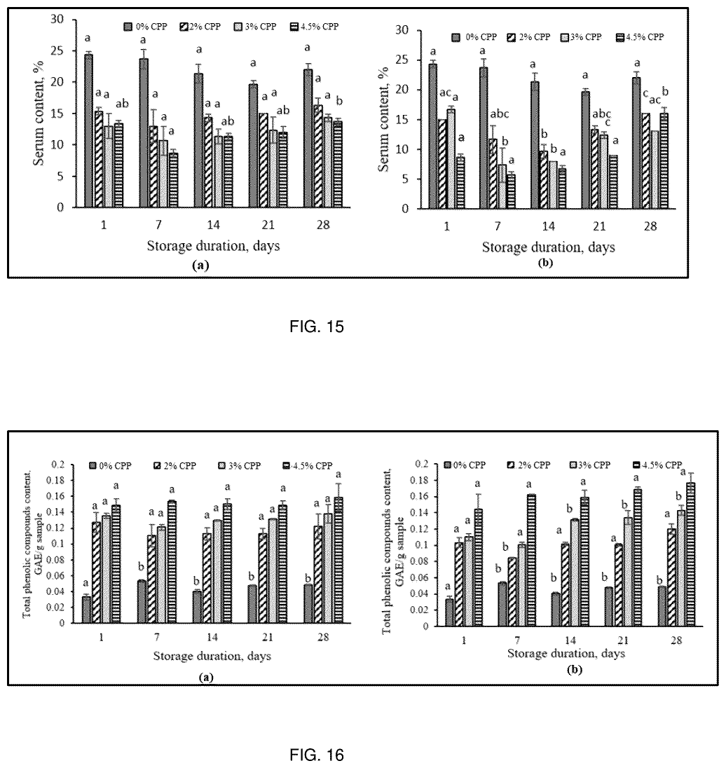

These tendencies were obtained by evaluating the antioxidant activity of yogurt by three different parameters: DPPH⁻, ABTS⁻⁺ and ORAC. One of the reasons for this phenomenon may be the stable total phenolic compounds content found in the CPP-enriched yogurt samples during storage (FIG. 16).

Digestibility of yogurt made by adding dietary fiber-rich cranberry pomace powders (CP) after (I method) or before (II method) fermentation. The last stage of the research work aimed to evaluate whether the addition of CPP to yogurt affects the digestibility of the product. Although CPP is rich in valuable dietary fiber, phenolic compounds, and other health-relevant substances, there is no evidence that the CPP tends to retain its functional properties when CPP-enriched yogurt reaches the digestive tract. It is also important to demonstrate the influence of CPP on the digestion rate of other yogurt nutrients, such as proteins, and bioavailability of phenolic compounds. The results described in the previous sections showed that the addition of CPP increases the viscosity of yogurt, a possible interaction between dietary fibers and phenolic compounds in CPP and casein, which may have a negative effect on the rate of protein digestion and the release of phenolic compounds in the digestive tract. In order to test these hypotheses, yogurt samples enriched with different amounts of CPP, added before or after fermentation, were subjected to simulated digestion at different stages of the digestive tract. In order to evaluate the digestibility of the yogurt, the degree of protein hydrolysis, the bioavailability index of phenolic compounds and the antioxidant activity at different stages of digestion were determined.

In the CPP-fortified yogurt, after the gastric stage of digestion, the BI of the phenol compounds increased with CPP in a dose-dependent manner for CPP added both before and after fermentation (Table 14).

TABLE 14
Changes of protein hydrolysis degree and bioavailability index of phenolic compounds of yogurt made
by adding different amounts of CPP before or after fermentation during static in vitro digestion

| | | | | | Yogurt produced by adding CPP before fermentation | | |
|---|---|---|---|---|---|---|---|
| Stage of | Yogurt made by adding CPP after fermentation (I method) | | | | (II method) | | |
| digestion | 0% CPP | 2% CPP | 3% CPP | 4.5% CPP | 2% CPP | 3% CPP | 4.5% CPP |
| | Protein hydrolysis degree, % | | | | | | |
| Post-gastric | 11.77 ± 1.50a | 15.34 ± 1.41aA | 20.29 ± 0.73bA | 23.89 ± 3.39bA | 10.05 ± 1.73aB | 8.42 ± 5.39aA | 7.96 ± 0.05aB |
| Post-intestinal | 60.96 ± 10.50a | 61.27 ± 3.02aA | 78.14 ± 2.49bcA | 82.72 ± 1.99cA | 17.82 ± 2.06bB | 18.62 ± 1.66bB | 26.08 ± 4.51cB |
| | Bioavailability index of phenolic compounds, % | | | | | | |
| Post-gastric | — | 79.35 ± 0.47aA | 78.76 ± 0.18aA | 82.14 ± 0.69bA | 71.56 ± 0.19aB | 74.05 ± 0.28aB | 76.73 ± 3.14aA |
| Post-intestinal | — | 93.61 ± 0.65aA | 93.59 ± 2.82aA | 93.75 ± 3.00aA | 85.64 ± 1.82aA | 85.70 ± 0.33aA | 92.42 ± 0.52bA |

* Values are reported as means ± standard deviation;
lower case letters indicate significant (p < 0.05) differences between different CP content in yogurt;
upper case letters indicate significant (p < 0.05) differences between different CP addition method

The same tendency was observed after the intestinal phase of digestion. The BI after the intestinal stage of digestion of the CPP-fortified yogurt was significantly higher (p<0.05) than that determined for the CPP-fortified yogurt after the gastric stage of digestion.

In contrast, the degree of protein hydrolysis during gastrointestinal digestion seemed to be affected by both the amount of CPP and the timing of its addition. The degree of protein hydrolysis of all yogurt samples exhibited an increasing trend with increasing amounts of added CPP. In all samples, proteins were significantly (p<0.05) less degraded after the gastric stage of digestion than after the intestinal stage. In contrast, the stage during which the CPP was added to the yogurt seems to be of great importance for the digestibility of proteins. The yogurt with CPP added before fermentation exhibited significantly (p<0.05) lower post-gastric and post-intestinal degrees of protein hydrolysis compared to the yogurt with CP added after fermentation. This result could be related to the peculiarities of the structures determined for the differently prepared yogurts. A more compact network of casein aggregates embedded into the network of CP fibers (adding CPP to the yogurt before fermentation) hinders the access of gastric enzymes to target residues, resulting in practically undigested proteins (post-gastric degree of protein hydrolysis: 7.95%-10.05%). As a result, proteins remaining in the stomach can greatly affect the consistency characteristics of the gastric environment. This period of delayed stomach emptying can lead to feelings of gastric distension and fullness. It is also related to the slower hydrolysis of proteins by pancreatic proteases, which require more time for degradation and are more distally absorbed in the intestine. According to our results, adding CPP to the yogurt before fermentation will potentially improve the satiating ability of the product. In contrast, samples of the yogurt with CPP added after fermentation underwent gradual and more extended digestion during the gastric and intestinal stages. The open structure of casein aggregates with large pores, heterogeneously sized channels, and CPP fiber within these void spaces allows enzymes greater access to potential cleavage sites, increasing the degree of protein hydrolysis. In this case, slow emptying of the stomach can be predicted. Afterward, protein degradation products are hydrolyzed by pancreatic proteases and evenly absorbed in the upper part of the small intestine.

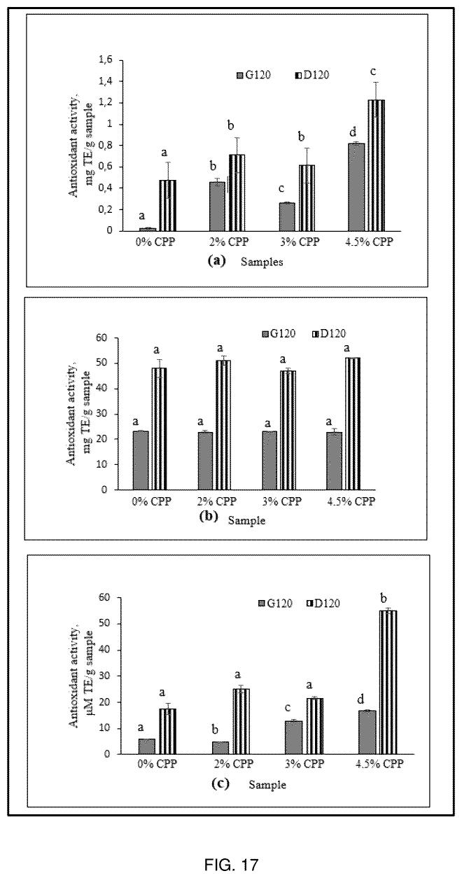

When evaluating the antioxidant properties of digested samples, it was found that higher antioxidant activity (AA) of yogurt samples (determined by DPPH·, ABTS·+, ORAC methods) was detected in the postintestinal phase than in the post gastric phase (FIG. 17). During digestion, yogurt was exposed to gastric and pancreatic enzymes that degrade proteins and promote the release of CPP phenolic compounds from phenol-protein complexes. Peptides and amino acids are also released, which can be characterized by AA and can be detected by quantitative methods for determining antioxidant properties. A positive correlation calculated by the Pearson equation, was found between the degree of protein hydrolysis and the DPPH• radical scavenging method (r=0.675), BHL and ABTS·+radical-cation scavenging capacity reaction method (r=0.958) and between BHL and ORAC oxygen radical absorbance capacity method (r=0.790) in the digested samples.

Incorporation of dietary fiber rich berry PP in frankfurters. In this part of the study, the effect of adding dietary fiber-rich lingonberry pomace powder (LPP) on the physicochemical, textural, and antioxidant properties of frankfurters during storage for 21 days was evaluated. As control frankfurters without LPP addition was used. The proximate chemical composition of frankfurters made with LPP showed that the addition of 5% LPP increased dietary fiber content by approximately 3.46% compared with control (Table 15). Therefore, frankfurters made with 5% LPP could be claimed as “a source of fiber” or “containing fiber”. This frankfurters formulation fulfills the European Food Safety Authority (EFSA) requirement for nutrient claims of having at least 3 g/100 g of dietary fiber (Reglament 1924).

TABLE 15
Chemical composition of frankfurters
made with and without of LPP

| | Frankfurters | Frankfurters |
|---|---|---|
| Chemical composition,/100 g | without LPP | with LPP |
| Water content | 64.28 ± 0.51 | 59.53 ± 0.41 |
| Protein content | 12.23 ± 0.08 | 12.59 ± 0.09 |
| Fat content | 18.15 ± 0.05 | 18.68 ± 0.04 |
| Dietary fiber content | 0 | 3.46 ± 0.02 |
| Carbohydrates content | 0.52 ± 0.002 | 0.53 ± 0.003 |
| Energetic value, kJ | 214.35 | 227.00 |

*Calculated as 100 − (fat + ash + protein + total dietary fiber)

In general, the frankfurters produced with LPP remained relatively stable throughout storage for 21 days. In more detail, the pH values of frankfurters with LPP remained stable, in the range of 5.51-5.49, while the considerable decrease of pH from 6.23 to 5.72 was demonstrated in the frankfurters without LPP (Table 15). The lower pH values in the frankfurters with LPP is determined by the composition of lingonberries, which are rich in organic acids such as citric, malic, benzoic, oxalic, acetic, glyoxylic, pyruvic, oxypyruvic. Color is one of the most important indicators of frankfurters quality, the change of which is undesirable during product shelf life. Storage duration the changes of a*, L* and b* values of frankfurters with LPP were extremely small. After production of frankfurters with LPP, lightness was 57.79, redness—11.34, and yellowness—6.353. After 21 days of storage, lightness was 57.63, redness—11.89, yellowness—6.92 (Table 16). While, the frankfurters produced without LPP became lighter (L* value increased from 82.90 to 86.06) slightly redder (a* value increased from 3.70 to 4.37) and their b* value decreased from 14.56 to 13.57 showing the decrease of yellowness during storage for 21 days. So, the improvement of color stability during shelf life of frankfurters produced with LPP was demonstrated.

TABLE 16
Color of frankfurters made with or without
LPP during storage (21 days)

| | Storage | Frankfurters | |
|---|---|---|---|
| Color values | duration | without LPP | Frankfurters with LPP |
| L* | 0 | 82.99 ± 0.23aA | 54.79 ± 0.12aB |
| | 7 | 83.94 ± 0.42bA | 56.01 ± 0.36bB |
| | 14 | 84.34 ± 0.23bA | 57.41 ± 0.09cB |
| | 21 | 86.06 ± 0.36cA | 57.63 ± 0.36cB |
| a* | 0 | 3.7 ± 0.23aA | 11.34 ± 0.09aB |
| | 7 | 4.21 ± 0.21aA | 11.64 ± 0.22aB |
| | 14 | 4.43 ± 0.09cA | 11.18 ± 0.15cB |
| | 21 | 4.37 ± 0.08bA | 11.89 ± 0.23bB |
| b* | 0 | 14.56 ± 0.34aA | 6.35 ± 0.08bB |
| | 7 | 13.26 ± 0.16bA | 5.81 ± 0.12cB |
| | 14 | 12.77 ± 0.16cA | 5.75 ± 0.14cB |
| | 21 | 13.57 ± 0.12bA | 6.92 ± 0.99aB |

Values are reported as means ± standard deviation; lower case letters indicate significant (p < 0.05) differences between values at different storage period; upper case letters indicate significant (p < 0.05) differences between frankfurters made with and without LPP

The texture of frankfurters was evaluated by hardness, springiness, cohesiveness and chewiness (Table 17). At the beginning of shelf life, all textural parameters of the frankfurters made with LPP were significantly lower, than those of the control samples.

However, the values of hardness, elasticity, cohesiveness and chewiness during the storage of frankfurters with LPP (21 day) remained stable. The recorded changes are slight and statistically insignificant (p>0.05). Different results were found when evaluating the textural parameters of frankfurters made without LPP. During storage up to day 21, the values of hardness, springiness, cohesiveness decreased statistically significantly (p<0.05) and the value of chewiness increased during storage of control sample. These results indicated that textural properties of frankfurters with LPP remain stable during storage due to the ability of LPP to bind water and oil.

TABLE 17
Textural properties of frankfurters made
with or without LPP during storage.

| | Storage | Frankfurters | |
|---|---|---|---|
| | duration | without LPP | Frankfurters with LPP |
| Hardness, N | 0 | 72.03 ± 0.65aA | 62.36 ± 0.55aB |
| | 7 | 70.17 ± 0.86bA | 61.28 ± 0.31bB |
| | 14 | 68.71 ± 0.47cA | 60.64 ± 0.40bB |
| | 21 | 66.87 ± 0.41dA | 60.58 ± 0.09bB |
| Springiness, mm | 0 | 0.75 ± 0.05aA | 0.71 ± 0.10aB |
| | 7 | 0.72 ± 0.04bA | 0.71 ± 0.02aB |
| | 14 | 0.70 ± 0.05cA | 0.70 ± 0.02bA |
| | 21 | 0.67 ± 0.01dA | 0.70 ± 0.01bB |
| Cohesiveness | 0 | 0.34 ± 0.12aA | 0.22 ± 0.01aB |
| | 7 | 0.30 ± 0.02aA | 0.21 ± 0.01bB |
| | 14 | 0.30 ± 0.03aA | 0.21 ± 0.02bB |
| | 21 | 0.27 ± 0.01bA | 0.21 ± 0.01bB |
| Chewiness, N mm | 0 | 20.29 ± 0.21aA | 14.78 ± 0.75aB |
| | 7 | 20.04 ± 0.25aA | 15.06 ± 0.18aB |
| | 14 | 20.75 ± 0.61aA | 15.61 ± 0.19bB |
| | 21 | 30.27 ± 0.46bA | 15.55 ± 0.86bB |

Values are reported as means ± standard deviation; lower case letters indicate significant (p < 0.05) differences between values at different storage period; upper case letters indicate significant (p < 0.05) differences between frankfurters made with and without LPP

Analysis of antioxidant activity of frankfurters during the entire storage period showed that, the antioxidant activity of the products made with or without LPP decreased significantly (Table 18). These tendencies were obtained by evaluating the antioxidant activity of frankfurters by DPPH*. However, for the frankfurters made with LPP, the antioxidant activity after 21 days of storage was still about 10 times higher than that of the frankfurters without LPP. One of the reasons of such phenomenon could be the higher total phenols content detected in the frankfurters with LPP, which was significantly higher in these samples during the entire storage period in comparison with the control.

TABLE 18
Total phenolic compounds content and antioxidant activity of frankfurters
made with and without LPP during storage (21 days)

| | Storage | | |
|---|---|---|---|
| | duration, | Frankfurters | Frankfurters |
| | days | without LPP | with LPP |
| Total phenolic content, | 0 | 0.101 ± 0.01aA | 0.23 ± 0.2aB |
| mg GAE/g sample | 7 | 0.037 ± 0.02bA | 0.19 ± 0.05bB |
| | 14 | 0.026 ± 0.04cA | 0.10 ± 0.02cB |
| | 21 | 0.018 ± 0.03dA | 0.08 ± 0.01cB |
| DPPH, μmol TE/g | 0 | 20.64 ± 0.91aA | 38.64 ± 1.12aB |
| sample | 7 | 18.07 ± 1.10bA | 31.89 ± 0.73bB |
| | 14 | 4.53 ± 0.85cA | 29.05 ± 1.15bB |
| | 21 | 2.09 ± 1.02dA | 22.86 ± 0.92cB |
| TBARS activity | 0 | 0.024 ± 0.006 | 0.061 ± 0.002 |
| | 7 | 0.034 ± 0.003 | 0.051 ± 0.003 |
| | 14 | 0.344 ± 0.008 | 0.053 ± 0.008 |
| | 21 | 0.066 ± 0.004 | 0.049 ± 0.002 |

Values are reported as means ± standard deviation; lower case letters indicate significant (p < 0.05) differences between values at different storage period; upper case letters indicate significant (p < 0.05) differences between frankfurters made with and without LPP

The results of antioxidant activity also explain the change in the lipid oxidative stability observed for the frankfurters during storage. Thiobarbituric acid reactive substances (TBARS) were measured in the frankfurters during storage and that was considered as an indicator of quality for the products exhibiting secondary lipid oxidation products. At the beginning of shelf life TBARS values in the frankfurters with or without LPP were low and at the same level (Table 18). However, significant changes were visible on 21st day of storage, when the level of TBARS in the control sample increased up to 0.344 mg MDA/kg while it remained low (0.052 mg MDA/kg) in the frankfurters with LPP. Phenolic compounds presented in frankfurters with LPP act as strong antioxidants that scavenge free radicals and hinder the oxidation chain reactions.

Finally, we evaluated whether the addition of LPP to frankfurters affects the digestibility of the product by measuring the digestion rate of other frankfurters nutrients, such as proteins, fat and bioavailability of phenolic compounds. Frankfurters made without and with LPP were subjected to simulated digestion at different stages of the digestive tract. In order to evaluate the digestibility of the frankfurters, the degree of protein hydrolysis, the release of fat and phenolic compounds and the antioxidant activity at different stages of digestion were determined.

TABLE 19
Changes of protein hydrolysis degree, phenolic compounds release and antioxidant activity
of frankfurters made with and without LPP during static in vitro digestion

| Digestibility | Frankfurters without LPP | | Frankfurters with LPP | |
|---|---|---|---|---|
| indices | Post-gastric | Post-intestinal | Post-gastric | Post-intestinal |
| Protein | 10.04 ± 1.41aA | 63.36 ± 1.75bA | 10.86 ± 1.08aA | 81.98 ± 1.55bB |
| hydrolysis | | | | |
| degree, % | | | | |
| Released fat | 94.51 ± 2.14aA | 105.20 ± 1.85bA | 105.15 ± 1.22aB | 117.87 ± 0.98bB |
| content, mg/g | | | | |
| sample | | | | |
| Released | 0.116 ± 0.05aA | 0.677 ± 0.03bA | 0.336 ± 0.06aB | 0.810 ± 0.06bB |
| phenolic | | | | |
| compounds | | | | |
| content, GRE/g | | | | |
| sample | | | | |
| Antioxidant | | | | |
| activity: | | | | |
| DPPH, mg TE/g | 0.33 ± 0.01aA | 0.41 ± 0.01bA | 0.40 ± 0.01aB | 1.98 ± 0.01bB |
| sample | | | | |
| ABTS, mg TE/g | 3.65 ± 0.15aA | 7.82 ± 0.00bA | 3.86 ± 0.02aA | 9.79 ± 0.02bB |
| sample | | | | |
| ORAC, μM | 36.94 ± 1.88aA | 96.65 ± 0.19bA | 70.76 ± 3.55aB | 126.44 ± 4.45bB |
| TE/g sample | | | | |

* Values are reported as means ± standard deviation; lower case letters indicate significant (p < 0.05) differences between post-gastric and post-intestinal phases; upper case letters indicate significant (p < 0.05) differences between frankfurters made with and without LPP

The observed changes in the degree of protein hydrolysis after gastric and intestinal digestion demonstrate that proteins in the frankfurters with added LPP tended to be more completely digested in comparison with frankfurters without LPP (Table 19). The addition of LPP to the frankfurters caused the faster release of fat and phenolic compounds as well. A significant increase (p<0.05) in the degree of protein hydrolysis, fat release and phenolic compounds release was observed for all samples after the pancreatic stage of digestion when compared to post-gastric samples. The improved digestibility of frankfurters with LPP demonstrated herein may be related to the structural changes caused by incorporated dietary fibers.

Due to the softer texture of frankfurters with LPP (see Table 17) proteins become more susceptible to digestive enzymes, which break down meat proteins in the frankfurters and intensify the processes of phenolic compounds release from the degraded structure. When evaluating the antioxidant properties of digested samples, it was found that higher antioxidant activity (determined by DPPH·, ABTS·+, ORAC methods) was detected for the frankfurters with added LPP than that detected for the frankfurters without LPP during post-gastric and post-intestinal phases (Table 19). In all cases antioxidant activity of the

1. A composition, comprising berry pomace powder, wherein the berry pomice powder contains dietary fiber with soluble dietary fiber/insoluble dietary fiber ratio in the range of about 0.08-0.21, wherein total insoluble dietary fiber is in the range of about 58.69 to 65.36 g/100 g; wherein the total soluble dietary fiber is in the range of about 4.92 to 12.74 g/100 g; wherein cholesterol binding capacity is in the range of about 14.16 to 23.13 mg/g; wherein sodium cholate binding capacity, when pH equals 7, is in the range of about 24.66 to 52.68 mg/g; wherein total phenolic content is in the range of about from 5.65 to 13.54 mg GA/g.

2. The composition according to claim 1, wherein the berry-pomace-powder is cranberry pomace-powder.

3. The composition according to claim 1, wherein the berry-pomace-powder is lingonberry pomace-powder.

4. The composition according to claim 1, wherein the berry-pomace-powder is sea-buckthorn pomace-powder.

5. Method of use of the berry-pomace-powder according to claim 2, comprising:
adding said berry-pomace-powder to yogurt in a proportion of 4.5% per weight of the yogurt composition; and
mixing the yogurt and BPP mixture for 2 to 3 minutes at a temperature range from 15 to 20 C.

6. Method of use of the berry-pomace-powder according to claim 3, comprising:
adding said berry-pomace-powder to the composition of sausages, wherein the sausage composition comprises 5% of lingonberry pomace-powder per weight.
